(19) United States
(12) Patent Application Publication
(10) Pub. No.: US 2007/0231577 A1
(43) Pub. Date: Oct. 4, 2007

(54) COATINGS FOR POLYCARBONATE WINDOWS

(75) Inventors: Lyle A. Caillouette, Farmington, MI (US); Paul E. Lamberty, Romeo Bruce, MI (US); Thomas C. Balch, West Bloomfield, MI (US)

Correspondence Address: BASF CORPORATION;Patent Department, 1609 BIDDLE AVENUE, MAIN BUILDING, WYANDOTTE, MI, 48192, US

(73) Assignee: BASF Corporation, Southfield, MI (US)

(21) Appl. No.: 11/278,036

(22) Filed: Mar. 30, 2006

(51) Int. Cl. B32B 27/36

(52) U.S. Cl. 428/412

(57) ABSTRACT

An optically transparent polycarbonate article is disclosed, comprising a polycarbonate substrate coated with at least one ultraviolet-blocking coating, including a radiation curable component that polymerizes upon exposure to actinic radiation, a thermally curable binder component that polymerizes upon exposure to heat, a thermally curable crosslinking component, and at least one additive for protection of the polycarbonate substrate from UV radiation. A method for producing a UV-blocking coated polycarbonate article is also disclosed.

### FIELD

The present disclosure relates to a polycarbonate substrate coating composition that is curable upon exposure to both actinic radiation and thermal energy.

### BACKGROUND

The statements in this section merely provide background information related to the present disclosure and may not constitute prior art.

Polycarbonate has found extensive acceptance as a material with outstanding impact strength, superior dimensional stability, glass-like transparency, excellent thermal resistance, and low-temperature toughness. Polycarbonate is widely used in a broad range of industries, including automotive and transportation, building and construction, electrical and electronics, telecommunication, packaging, medical, optical/opthalmic, and optical media.

An emerging application for polycarbonate is automotive window systems. Polycarbonate provides lower weight, resulting in a lower center of gravity and reduced fuel consumption. Additionally, the superior strength and impact resistance of polycarbonate, in comparison to glass and acrylics, minimizes the potential for breakage during an accident or attempted theft.

When polycarbonate is employed as a glass substitute, however, polycarbonate must be resistant to environmental influences (i.e., have weatherability or weathering stability). Stringent optical clarity requirements must also be met for polycarbonate when used in window applications, and polycarbonate glass substitutes must closely match the optics of glass. Increased resistance to degradation from ultraviolet (UV) light exposure, where exposure to such radiation causes yellowing, darkening, and chalking of the polycarbonate, is also desired for such applications.

Various methods have been attempted in the past to incorporate a UV stabilizer into polycarbonate to minimize exposure degradation. For some applications, UV resistance has been attempted by mechanically incorporating UV stabilizers into the polycarbonate. However, it has been found that there is a maximum amount of UV stabilizer which may be incorporated into polycarbonate before adversely affecting physical properties, e g coloration and optical clarity This has been a limiting factor in the amount of UV stabilization which can be introduced into polycarbonate.

Moreover because the molecular structures of UV stabilizers are often so different from the molecular structure of polycarbonate, UV stabilizers are often incompatible with polycarbonate materials.

An alternative to loading polycarbonate with UV stabilizers is to use surface coatings or glazings that are UV absorbing. These coatings must not only be UV absorbent and protect the polycarbonate substrate from UV radiation, but such coatings must also have excellent optical clarity, long-term weathering stability, and adhesion to the polycarbonate substrate. Coatings for UV absorption are preferably easy to apply, for example by spray methods. Often, the coatings of the art require an intermediate primer coating to improve adhesion to the polycarbonate substrate. Good adhesion directly to polycarbonate, as well as to further coatings applied for enhanced scratch-resistance, such as organosilicon plasma coatings, is therefore very desirable.

Accordingly, there is a continuing interest in improving the weatherability of polycarbonate articles through UV absorbing surface coatings.

### SUMMARY OF THE DISCLOSURE

The polycarbonate article and method of the disclosure addresses the aforementioned needs. The polycarbonate article includes a polycarbonate substrate coated with at least one ultraviolet-blocking coating composition, including a radiation curable component that polymerizes upon exposure to actinic radiation, a thermally curable binder component that polymerizes upon exposure to heat, a thermally curable crosslinking component, and at least one additive for protection of the polycarbonate substrate from UV radiation. The article is substantially clear and transparent, and meets the applicable standards for optical clarity and weatherability when used as an automotive window.

The method for producing an optically clear polycarbonate article, coated with an ultraviolet-blocking coating, includes applying a coating to a polycarbonate substrate. The coating may be applied by various means, and in certain embodiments may be applied by spraying techniques. The coating is a dual cure coating, which means that the coating may be cured by actinic radiation and thermal energy. Other coatings, such as additional UV-absorbing coatings or scratch resistant coatings, may also be applied.

It has been surprisingly found that the polycarbonate articles obtained by the process of the disclosure possess outstanding optical clarity, and that the weatherability of the coated polycarbonate articles of the disclosure is excellent. The articles exhibit unexpectedly superb substrate/coating adhesion and coating/coating adhesion, eliminating the need for intermediate adhesion promoting coatings. In addition, coated articles and substrates of the disclosure have outstanding crack resistance and enhanced durability.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

Further areas of applicability will become apparent from the description provided herein. It should be understood that the description and specific examples are intended for purposes of illustration only and are not intended to limit the scope of the present disclosure.

### DETAILED DESCRIPTION OF THE DISCLOSURE

The following description is merely exemplary in nature and is not intended to limit the present disclosure, application, or uses.

The present disclosure provides an article including a polycarbonate substrate and at least one UV absorbing coating. The polycarbonate substrate may be optically transparent and may be optically clear. Nonlimiting examples of articles according to the disclosure include automotive windows, headlamps, mirrors, lenses, or other articles generally comprising optically clear glass. In particular, the polycarbonate article of the disclosure may be an automotive window system.

Suitable polycarbonate materials include, but are not limited to, polycarbonate materials well known in the art. Polycarbonate materials are preferred as transparent substrates for the automotive windows of the disclosure because of their excellent physical, mechanical, and chemical properties.

Polycarbonates in the context of the present disclosure may be aliphatic or aromatic carbonate polymers. In general, the polycarbonates of the disclosure may be homopolycarbonates or copolycarbonates, meaning they may be synthesized using one or more type of dihydroxy-substituted aromatic hydrocarbon, and may also be linear or branched. Polycarbonates which contain both acid radicals of carbonic acid and acid radicals of aromatic dicarboxylic acids incorporated into the molecular chain, sometimes called aromatic polyester-carbonates, are also summarized under the generic term of polycarbonates. The term “polycarbonate” is meant herein to additionally include transparent polymer blends of polycarbonates with various other materials, such as polyesters and impact modifiers.

Polycarbonates suitable for forming a transparent substrate are well-known in the art and are described, for example in U.S. Pat. Nos. 4,200,681, 4,842,941, and 4,210,699. Such polycarbonates generally comprise repeating units of the formula 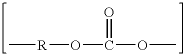
in which R is a divalent radical of a dihydric phenol. A typical divalent radical of a dihydric phenol is a radical of 2,2-bis(4-hydroxyphenyl)-propane, also known as bisphenol A, of the formula

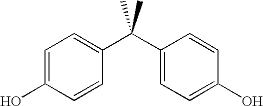

Polycarbonates within the scope of the present disclosure may also be prepared by several well-known methods. Reference by way of example is made here methods incorporated in U.S. Pat. Nos. 5,156,882 and 6,5488,146, and “Polycarbonates” in Encyclopedia of Polymer Science and Engineering, volume 11, 1988, second edition, 1988 pages 648-718.

For example, the production of polycarbonate by transesterification of carbonic esters with dihydroxyl compounds is well known in the art. Transesterification is particularly suitable for the production of the homopolycarbonate of bisphenol A. To this end, bisphenol A is transesterified with carbonic esters, preferably diphenyl carbonate. The process for producing polycarbonate by transesterification is also suitable for the production of copolycarbonates based on bisphenol A and further dihydroxy-substituted aromatic hydrocarbon compounds as participants in the copolymerization.

In the production of polycarbonate by transesterification, the coreactants (dihydroxyl compounds and carbonic esters and optionally further auxiliary substances and additives such as, for example, branching agents) are generally reacted together in multistep reactions, and preferably with addition of a transesterification catalyst or of a combination of several transesterification catalysts, with splitting-off of a hydroxyl compound from the carbonic ester Typically, if the carbonic ester used is diphenyl carbonate, the hydroxyl compound split off is phenol.

As a further nonlimiting example, polycarbonate polymers may be prepared by reacting one or more dihydric phenols with a carbonate precursor, such as a phosgene or other carbonyl halides. Alternatively, one or more dihydric phenols may be reacted with carbonate precursors such as a haloformate or a carbonate ester.

The polycarbonates according to the disclosure may further comprise additives, such as fillers, plasticizers, tint color additives, and the like, inasmuch as the additives do not significantly affect the optical clarity of the polycarbonate article.

Nonlimiting examples of polycarbonates useful for the articles of the disclosure are MAKROLON®, manufactured by Bayer MaterialScience, and LEXAN®, produced by General Electric Company. In general, the choice of polycarbonate type or composition is ultimately determined by the use contemplated for the coated article.

It should be understood that polycarbonate substrates according to the disclosure are solid, as opposed to microporous, porous, or foamed polycarbonate. The solidity of the polycarbonate articles of the disclosure facilitates optical clarity.

The polycarbonate articles of the disclosure are coated with “dual cure” coating compositions, which are subsequently cured to provide UV blocking coatings on the polycarbonate article. As defined herein, “dual cure” refers to curable coating compositions that require exposure to both actinic radiation and thermal energy to achieve a degree of crosslinking and achieve desired performance properties. Thus, in one aspect, the coating compositions of the disclosure are at least partially curable or polymerizable upon exposure to some portions of the electromagnetic radiation spectrum. In another aspect of the disclosure, the coating compositions of the disclosure are at least partially thermally curable or polymerizable upon exposure to thermal or heat energy. It is preferred that the coatings are substantially clear and transparent.

Radiation cure and thermal cure may occur sequentially or concurrently. In a preferred embodiment, the coating compositions of the disclosure will be subjected to a first stage of curing followed by a second stage of curing. Either radiation cure or thermal cure may occur first. In a most preferred embodiment, the coating compositions of the disclosure will first be subjected to actinic radiation, especially UV radiation, followed by a second stage of cure, wherein the coating compositions previously subjected to actinic radiation will be subjected to a thermal cure.

It is within the scope of the disclosure that the second stage cure does not have to immediately succeed the first stage and can occur after the application of one or more subsequently applied coatings. For example, it is within the scope of the disclosure to apply one or more additional coating compositions to the radiation cured coating of the disclosure and then simultaneously thermally cure the one or more additionally applied coatings together with the radiation cured coating of the disclosure.

Actinic radiation as used herein refers to energy having wavelengths of less than 500 nm and corpuscular radiation such as electron beam. Preferred actinic radiation will have wavelengths of from 180 to 450 nm, i e, in the UV region. More preferably, the actinic radiation will be UV radiation having wavelengths of from 225 to 450 nm. The most preferred actinic radiation will be UV radiation having wavelengths of from 250 to 425 nm.

Heat or thermal energy, as used herein refers to the transmission of energy by either contact via molecular vibrations or by certain types of radiation.

Heat energy transferred by radiation as used herein refers to the use of electromagnetic energy generally described as infrared (IR) or near-infrared (NIR), i.e., energy having an approximate wavelength of from 800 nm to 10⁻³ m.

Heat as used herein also encompasses energy transferred via convection or conduction. Convection refers to the transmission of heat by the rise of heated liquids or gases and the fall of colder parts. Conduction may be defined as the transmission of matter or energy. Transmission of heat energy via convection is especially preferred.

The coating compositions of the disclosure comprise at least four components, a radiation curable component (a1) that polymerizes upon exposure to actinic radiation, especially UV radiation, a thermally curable binder component (a2) that polymerizes upon exposure to heat, a thermally curable crosslinking component (a3) that has at least 2 isocyanate groups per molecule, and at least one additive (a4) for absorbing or otherwise preventing transmission of ultraviolet radiation.

Radiation curable component (a1) contains on average at least two functional groups per molecule, and more preferably at least three functional groups. Each functional group will preferably have at least one bond that is activatable upon exposure to actinic radiation, especially UV radiation, so as to crosslink. In a particularly preferred embodiment, each functional group will have one UV activatable bond.

In a preferred embodiment, the radiation curable component (a1) of the disclosure will comprise not more than six functional groups on average per molecule, and most preferably not more than five functional groups on average per molecule.

Examples of suitable bonds that can be activated with actinic radiation, and especially UV radiation, are carbon-hydrogen single bonds, carbon-carbon single bonds, carbon-oxygen single bonds, carbon-nitrogen single bonds, carbon-phosphorus single bonds, carbon-silicon single bonds, carbon-carbon double bonds, carbon-oxygen double bonds, carbon-nitrogen double bonds, carbon-phosphorus double bonds, carbon-silicon double bonds, or carbon-carbon triple bonds. Of these, the double bonds are preferred, with the carbon-carbon double bonds being most preferred.

Highly suitable carbon-carbon double bonds are present, for example, in at least one of a (meth)acrylate group, an ethacrylate group, a crotonate group, a cinnamate group, a vinyl ether group, a vinyl ester group, an ethenylarylene group, a dicyclopentadienyl group, a norbornenyl group, a isoprenyl group, an isopropenyl group, an allyl group, a butenyl group, an ethenylarylene ether group, a dicyclopentadienyl ether group, a norbornenyl ether group, an isoprenyl ether group, an isopropenyl ether group, an allyl ether group, a butenyl ether group, an ethenylarylene ester group, a dicyclopentadienyl ester group, a norbornenyl ester group, an isoprenyl ester group, an isopropenyl ester group, an allyl ester group, and a butenyl ester group. It will be appreciated that (meth)acrylics and (meth)acrylates refer to both acrylates and methacrylates as well as acrylics and methacrylics. Of these, (meth)acrylate groups are preferred, with acrylate groups being most preferred.

Radiation curable component (a1) may further comprise at least one functional group that is reactive with the isocyanate groups of thermally curable crosslinking component (a3).

Examples of suitable isocyanate-reactive groups include, but are not limited to, thiol groups, primary amino groups, secondary amino groups, imino groups, and hydroxyl groups, with hydroxyl groups being most preferred.

Radiation curable component (a1) may further comprise at least one functional group that is a hydroxyl-reactive functional group. Examples of suitable hydroxyl-reactive groups include, but are not limited to, isocyanates, aminoplasts, epoxy groups, silane groups, cyclic anhydrides, and cyclic lactones.

Radiation curable component (a1) may be oligomeric or polymeric. In the context of the present disclosure, an oligomer is a compound containing in general on average from 2 to 15 monomer units. A polymer, in contrast, is a compound containing in general on average at least 10 monomer units. Such compounds may also be referred to as binders or resins. In contrast, a low molecular mass compound in the context of the present disclosure refers to a compound that derives substantially from only one basic structure or monomer unit. Compounds of this kind may also be referred to as reactive diluents and are discussed below in regards to optional reactive diluent component (a5).

Radiation curable component (a1) will generally have a number average molecular weight of from 500 to 50,000, preferably from 1000 to 5000. In a preferred aspect of the disclosure, the sum of radiation curable component (a1) and any optional reactive diluents (a5) will preferably have a double bond equivalent weight of from 400 to 2000, more preferably of from 500 to 900. In addition, the combination of radiation curable components (a1) and any optional reactive diluents (a5) will preferably have a viscosity at 23° C. of from 250 to 11,000 m Pas.

Radiation curable component (a1) may be employed in an amount of from 1 to 50% by weight, preferably from 3 to 45% by weight, and most preferably from 5 to 20% by weight, based in each case on the total nonvolatile solids of the film-forming components of the coating composition of the disclosure. Film-forming components as used herein refers to components such as radiation curable component (a1), thermally curable binder component (a2), thermally curable crosslinking component (a3), optional reactive diluent (a5), and any other monomeric, oligomeric or polymeric components that chemically react with any of components (a1), (a2), or (a3) so as to enter into the resulting polymerized network.

Examples of binders or resins suitable for use as radiation curable component (a1) include, but are not limited to, the oligomer and/or polymer classes of the (meth)acryloyl-functional (meth)acrylic copolymers, polyether acrylates, polyester acrylates, polyesters, epoxy acrylates, urethane acrylates, amino acrylates, melamine acrylates, silicone acrylates and phosphazene acrylates, the corresponding (meth)acrylates, vinyl ethers, and vinyl esters. However, acrylic and acrylate species are preferred over methacrylic and methacrylate species.

Radiation curable component (a1) will preferably be free from aromatic structural units. Preference is given to using urethane (meth)acrylates, phosphazene (meth)acrylates, and/or polyester (meth)acrylates, with urethane (meth)acrylates, with aliphatic urethane acrylates being most preferred.

Urethane (meth)acrylates suitable for use as radiation curable component (a1) may be obtained by reacting a diisocyanate or a polyisocyanate with a chain extender that is at least one of a diol, a polyol, a diamine, a polyamine, a dithiol, a polythiol, and an alkanolamine, and then reacting the remaining free isocyanate groups with at least one hydroxyalkyl (meth)acrylate or a hydroxyalkyl ester of one or more ethylenically unsaturated carboxylic acids The amounts of chain extenders, diisocyanates and/or polyisocyanates, and hydroxyalkyl esters in this case are preferably chosen so that 1) the ratio of equivalents of the isocyanate (NCO) groups to the reactive groups of the chain extender (hydroxyl, amino and/or mercaptyl groups) is between 3:1 and 1:2, and most preferably 2:1, and 2) the hydroxyl (OH) groups of the hydroxyalkyl esters of the ethylenically unsaturated carboxylic acids are stoichiometric with regard to the remaining free isocyanate groups of the prepolymer formed from isocyanate and chain extender.

It is also possible to prepare urethane (meth)acrylates suitable for use as radiation curable component (a1) by first reacting some of the isocyanate groups of a diisocyanate or polyisocyanate with at least one hydroxyalkyl ester and then reacting the remaining isocyanate groups with a chain extender. The amounts of chain extender, isocyanate, and hydroxyalkyl ester should also be selected such that the ratio of equivalents of the NCO groups to the reactive groups of the hydroxyalkyl ester is between 3:1 and 1:2, preferably.2:1, while the ratio of equivalents of the remaining NCO groups to the OH groups of the chain extender is 1:1.

It will be appreciated that urethane (meth)acrylates that result from other reaction mechanisms may also be suitable for use as radiation curable component (a1) in the instant disclosure. For example, some of the isocyanate groups of a diisocyanate may first be reacted with a diol, after that a further portion of the isocyanate groups may be reacted with a hydroxyalkyl ester, and subsequently reacting the remaining isocyanate groups with a diamine.

Illustrative examples of urethane (meth)acrylates suitable for use as radiation curable component (a1) include polyfunctional aliphatic urethane acrylates that are commercially available in materials such as CRODAMER® UVU 300 from Croda Resins Ltd., Kent, Great Britain; GENOMER® 4302, 4235, 4297, or 4316 from Rahn Chemie, Switzerland; EBECRYL® 284, 294, IRR 351, 5129, or 1290 from UCB, Drogenbos, Belgium; ROSKYDAL® LS 2989 or LS 2545 or V94-504 from Bayer AG, Germany; VIAKTIN® VTE 6160 from Vianova, Austria; or LAROMER® 8861 from BASF AG and experimental products modified from it.

Hydroxyl-containing urethane (meth)acrylates suitable for use as radiation curable component (a1) are disclosed in U.S. Pat. No. 4,634,602 A and U.S. Pat. No. 4,424,252 A. An example of a suitable polyphosphazene (meth)acrylate is the phosphazene dimethacrylate from Idemitsu, Japan.

The coating material further comprises at least one thermally curable binder component (a2) comprising at least two isocyanate-reactive groups. Examples of suitable isocyanate-reactive groups are those described above with respect to the isocyanate-reactive groups of radiation curable component (a1). Most preferably, the isocyanate reactive groups are hydroxyl groups.

At least 5% up to 100% of the binder component (a2) by solids weight of the binder component (a2) is a component (X) Component (X) is a polymer with at least two isocyanate reactive functional groups, a glass transition temperature (Tg) of less than 0° C., and an equivalent weight of greater than 225 grams per equivalent. Preferably, the Tg of the homopolymer is less than −20° C., and most preferably less than −50° C. Preferably, the equivalent weight is greater than 265. Preferably, component (X) is at least one of a polyether diol, a polyether polyol, a polyester diol, and a polyester polyol. Preferably, the amount is from 20% to 40%.

Examples of the polyether diol include, but are not limited to, polyoxyalkylenes. Examples of the polyoxyalkylenes include, but are not limited to, polyethylene oxide, polypropylene oxide, and polytetrahydrofuran. Generally, there are at least 4 repeating or monomer units in the polyether diol. Preferably, there are from 7 to 50 repeating units.

Examples of the polyether polyol include, but are not limited to, the polyether polyols sold under the trademarks LUPRANOL®, PLURACOL®, PLURONIC®, and TETRONIC® from BASF; ARCOL®, DESMOPHEN®, and MULTRANOL® from Bayer; VORANOL® from Dow; CARPOL® from E. R. Carpenter; PORANOL™ from Hannam, Korea; and KONIX™ from Korea Polyol.

Examples of suitable polyester diols include, but are not limited to polylactones (such as poly (ε-caprolactone)) and polyesters derived from dimer fatty acid, isophathlic acid, and 1,6-hexanediol. Preferably, the polyester diol is a poly (ε-caprolactone), which is available as TONE®201 or TONE®301 from Dow Chemical. Generally, there are at least 4 repeating units in the polyester diol or triol. Preferably, there are from 4 to 50 repeating units. Examples of polyester diols can be found in U.S. Pat. No. 5,610,224, which is incorporated herein by reference.

The polyester polyols may be formed from lactone extension of higher functional polyols, which are polyols having more than 3 OH groups. An example of the polyester polyol is an ε-caprolactone extension of pentaerythritol Generally there are at least one average 2 lactone monomer units per OH group on the polyol. Preferably, there are from 2 to 25 lactones per OH group on average. The polyester polyols can be prepared from low molecular weight alcohols and polybasic carboxylic acids such as adipic acid, sebacic acid, phthalic acid, isophthalic acid, tetrahydrophthalic acid, hexahydrophthalic acid, maleic acid, the anhydrides of these acids, and mixtures of these acids and/or acid anhydrides. Polyols suitable for the preparation of the polyester polyol include, but are not limited to, polyhydric alcohols such as ethylene glycol, propanediols, butanediols, hexanediols, neopentyl glycol, diethylene glycol, cyclohexanediol, cyclohexanedimethanol, trimethylpentanediol, ethylbutylpropanediol ditrimethylolpropane, trimethylolethane, trimethylolpropane, glycerol, pentaerythritol, dipentaerythritol, trishydroxyethyl isocyanate, polyethylene glycol, polypropylene glycol, and the like, as well as combinations of these. The polyol component may also include, if desired, minor amounts of monohydric alcohols, for example butanol, octanol, lauryl alcohol, and ethoxylated and propoxylated phenols. In another embodiment, a polyester polyol can be modified by reaction with a lactone. Further examples of polyester diols can be found in U.S. Pat. Nos. 6,436,477 and 5,610,224, both of which are incorporated herein by reference.

By including at least 5% of at least one of the polyether diol, the polyester diol or triol, and the polyester polyol in the coating composition, the flexibility of a coating prepared from the coating composition will be greater than the flexibility of a coating prepared from a coating composition that does not contain them. The flexibility is measured by % elongation, which is measured by stretching an 8 mm×4 mm×0.04 mm film at a rate of 0.0074 s⁻¹. These measurements are performed at room temperature on a Rheometric Scientific DMTA V. This method is described in Loren Hill, Progress in Organic Coatings, Volume 24, 1994, page 147 and Mark Nichols, Polymer Degradation and Stabilization, Volume 60, 1998, page 291.

While the at least one thermally curable binder component (a2) must have at least two isocyanate-reactive groups, more than two isocyanate groups are within the scope of the disclosure. In a particularly preferred embodiment, the thermally curable binder component (a2) will have from two to ten isocyanate-reactive groups per molecule, most preferably from two to seven isocyanate-reactive groups per molecule.

The thermally curable binder component (a2) is oligomeric or polymeric as defined above. Number average molecular weights of from 500 to 50,000 are suitable, with number average molecular weights of from 500 to 4000 preferred and those from 500 to 2000 being most preferred.

Oligomers and polymers generally suitable for use as thermally curable binder component (a2) may be (meth)acrylate copolymers, polyesters, alkyds, amino resins, polyurethanes, polylactones, polyester polyols, polycarbonates, polyethers, epoxy resin-amine adducts, (meth)acrylatediols, partially saponified polyvinyl esters of polyureas, and mixtures thereof. Particularly preferred oligomers and polymeric materials suitable for use as component (a2) are (meth)acrylate copolymers, polyesters, polyurethanes, and epoxy resin-amine adducts.

Polyesters having active hydrogen groups such as hydroxyl groups are especially suitable for use as thermally curable binder component (a2). Such polyesters may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

Suitable polyesters can be prepared by the esterification of a polycarboxylic acid or an anhydride thereof with a polyol and/or an epoxide. The polycarboxylic acids used to prepare the polyester consist primarily of monomeric polycarboxylic acids or anhydrides thereof having 2 to 18 carbon atoms per molecule. Among the acids that are useful are phthalic acid, hexahydrophthalic acid, sebacic acid, and other dicarboxylic acids of various types. Minor amounts of monobasic acids can be included in the reaction mixture, for example, benzoic acid, stearic acid, acetic acid, and oleic acid. Also, higher carboxylic acids can be used, for example, trimellitic acid and tricarballylic acid. Anhydrides of the acids referred to above, where they exist, can be used in place of the acid. Also, lower alkyl esters of the acids can be used, for example, dimethyl glutarate and dimethyl terephthalate.

Polyols that can be used to prepare the polyester include diols such as alkylene glycols. Specific examples include ethylene glycol, 1,4-butanediol, 1,6-hexanediol, neopentyl glycol, and 2,2-dimethyl-3-hydroxypropyl-2,2-dimethyl-3-hydroxypropionate. Other suitable glycols include hydrogenated Bisphenol A, cyclohexanediol, cyclohexanedimethanol, caprolactone-based diols such as the reaction product of c-caprolactone and ethylene glycol, hydroxy-alkylated bisphenols, polyether glycois such as poly(oxytetramethylene)glycol, and the like. Although the polyol component can comprise all diols, polyols of higher functionality can also be used. Examples of polyols of higher functionality would include trimethylolethane, trimethylolpropane, pentaerythritol, and the like.

Some thermally curable binders (a2) that may be suitable for use in the instant disclosure are commercially available under the trade names DESMOPHEN® 650, 2089, 1100, 670, 1200, or 2017 polyester polyols from Bayer, PRIPLAST® dimer based polyester polyols or PRIPOL® dimer fatty acid resins from Uniqema, Chempol®, polyester or polyacrylate-polyol from CCP, CRODAPOL® polyester polyol resins from Cray Valley, or LTS polyester polyol adhesion resins from Creanova.

However, it has been found that a particularly advantageous balance of performance properties can be achieved when thermally curable binder component (a2) has substantially no functional groups having bonds activatable upon exposure to UV radiation. Such functional groups may be those as described above with regards to the functional group of the radiation curable component (a1). Most preferably, thermally curable binder component (a2) will be a fully saturated compound.

Optionally, thermally curable component (a2) may also be selected to have a polydispersity (PD) of less than 4.0, preferably less than 3.5, more preferably a polydispersity of from 1 5 to less than 3 5 and most preferably a polydispersity of from 1.5 to less than 3.0. Polydispersity is determined from the following equation: (weight average molecular weight (M_{w})/number average molecular weight (Mₙ)). A monodisperse polymer has a PD of 1.0. Further, as used herein, Mₙ and M_{w} are determined from gel permeation chromatography using polystyrene standards.

In another optional aspect, the thermally curable binder component (a2) may also be selected so as to have less than 5% by weight of aromatic ring moieties, preferably no more than 2% by weight of aromatic ring moieties, and most preferably from 0% to less than 2% by weight of aromatic ring moieties, all based on the nonvolatile weight of thermally curable binder component (a2).

An especially preferred polyester for use as thermally curable binder component (a2) is SETAL™ 26-1615, commercially available from Nuplex of Louisville, Ky.

The amount of component (a2) in the coating compositions of the disclosure may vary widely and is guided by the requirements of the individual case. However, thermally curable binder component (a2) is preferably used in an amount of from 5% to 90% by weight, more preferably from 6% to 80% by weight, with particular preference from 7% to 70% by weight, with very particular preference from 8% to 60% by weight, and in particular from 9% to 50% by weight, based in each case on the total nonvolatile solids of the film-forming components of the coating composition.

The dual cure coating composition of the disclosure also comprises at least one thermally curable crosslinking component (a3). Most preferably, thermally curable crosslinking component (a3) will be a di- and/or polyisocyanate, with polyisocyanates being most preferred. Such di- and/or polyisocyanates may be blocked or unblocked.

The thermally curable crosslinking component (a3) will preferably contain on average at least 2 0, preferably more than 2.0, and in particular more than 3 0 isocyanate groups on average per molecule. There is basically no upper limit on the number of isocyanate groups; in accordance with the disclosure, however, it is of advantage if the number does not exceed 15, preferably 12, with particular preference 10, with very particular preference 8.0, and in particular 6.0. Most preferably, thermally curable crosslinking component (a3) will have from 2.5 to 3.5 isocyanate groups on average per molecule.

Examples of suitable diisocyanates are isophorone diisocyanate (i e., 5-isocyanato-i-isocyanatomethyl-1,3,3-trimethylcyclohexane), 5-isocyanato-1-(2-iso-cyanatoeth-1-yl)-1,3,3-trimethylcyclohexane, 5-iso-cyanato-1-(3-isocyanatoprop-1-yl)-1,3,3-trimethylcyclohexane, 5-isocyanato-(4-isocyanatobut-1-yl)-1,3,3-tri-methylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-di-isocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane-2,4-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate, methylpentyl diisocyanate (MPDI), nonane triisocyanate (NTI) or diisocyanates derived from dimer fatty acids, as sold under the commercial designation DDI 1410 by Henkel and described in the patent publications WO 97/49745 and WO 97/49747, especially 2-heptyl-3,4-bis(9-isocyanatononyl)-1-pentylcyclbhexane, or 1,2-, 1,4-, or 1,3-bis(isocyanatomethyl)cyclohexane, 1,2-, 1,4-, or 1,3-bis(2-isocyanatoethyl)cyclohexane, 1,3-bis(3-isocyanatopropyl)cyclohexane, 1,2-, 1,4-, or 1,3-bis (4-isocyanatobutyl)cyclohexane or liquid bis(4-isocyanatocyclohexyl)methane with a trans/trans content of up to 30% by weight, preferably 25% by weight, and in particular 20% by weight, as described in the patent applications DE 44 14 032 A1, GB 1220717 A1, DE 16 18 795 A1, and DE 17 93 785 A1, preferably isophorone diisocyanate, 5-isocyanato-1-(2-isocyanatoethyl)-1,3,3-trimethylcyclohexane, 5-isocyanato-1-(3-isocyanatopropyl)-1,3,3-trimethylcyclohexane, 5-isocyanato-(4-isocyanatobutyl)-1,3,3-trimethylcyclohexane, 1-isocyanato-2-(3-isocyanatopropyi)cyclohexane, 1-isocyanato-2-(3-isocyanatoethyl)cyclohexane, 1-isocyanato-2-(4-isocyanatobut-1-yl)cyclohexane, or HDI, with HDI being especially preferred.

Examples of suitable polyisocyanates are isocyanate-containing polyurethane prepolymers that can be prepared by reacting polyols with an excess of diisocyanates and that are preferably of low viscosity.

It is also possible to use polyisocyanates containing isocyanurate, biuret, allophanate, iminooxadiazindione, urethane, urea, carbodiimide and/or uretdione groups, prepared conventionally from the above-described diisocyanates. Examples of suitable preparation processes and polyisocyanates are known, for example, from the patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP0 303 150 A1, EP0 496 208 A1 , EPO 524 500 A1, EPO 566 037 A1, U.S. Pat. No. 5,258,482 A1, U.S. Pat. No. 5,290,902 A1, EP 0 649 806 A1, DE 42 29 183 A1, and EP 0 531 820 A1, or are described in the published European patent application EP1122273 A3. The isocyanurate of HDI is especially preferred for use as thermally curable crosslinking component (a3).

The high-viscosity polyisocyanates described in the German patent application DE 198 28 935 A1, or the polyisocyanate particles surface-deactivated by urea formation and/or blocking, as per the European patent applications EP 0 922 720 A1, EP 1 013 690 A1, and EP 1 029 879 A1 are also suitable for use as thermally curable crosslinking component (a3).

Additionally suitable are the adducts, described in the German patent application DE 196 09 617 A1, of polyisocyanates with dioxanes, dioxolanes and oxazolidines containing isocyanate-reactive functional groups and still containing free isocyanate groups.

Aminoplast resins are also suitable for use as thermally curable crosslinking component (a3). Examples of suitable aminoplast resins include melamine formaldehyde resin (including monomeric or polymeric melamine resin and partially or fully alkylated melamine resin including high imino melamines), urea resins (e.g., methylol ureas such as urea formaldehyde resin, alkoxy ureas such as butylated urea formaldehyde resin) and the like. Also useful are aminoplast resins where one or more of the amino nitrogens is substituted with a carbamate group for use in a process with a curing temperature below 150° C., as described in U.S. Pat. No. 5,300,328.

Examples of suitable tris(alkoxycarbonylamino)triazines are described in U.S. Pat. Nos. 4,939,213 and 5,084,541, and Eur. Pat. 0 624 577. Preferred are tris(methoxy-, tris(butoxy-, and/or tris(2-ethylhexoxycarbonylamino)triazine.

Most preferably, however, thermally curable crosslinking component (a3) will be a polyisocyanate such as the isocyanurate of HDI. In a particularly preferred embodiment, thermally curable crosslinking component (a3) will be substantially free of functional groups having bonds activatable upon exposure to actinic radiation, especially UV radiation. Such bonds are described above in regards to functional groups of component (a1). Most preferably, thermally curable crosslinking component (a3) will be a polyisocyanurate of HD[ that is substantially free of carbon-carbon double bonds.

The amount of thermally curable crosslinking component (a3) in the coating compositions of the disclosure will generally be from 5% to 70% by weight, more preferably from 10% to 60% by weight, with particular preference from 15% to 55% by weight, with very particular preference from 20% to 50% by weight, and in particular from 25% to 45% by weight, based in each case on the total nonvolatile of the film-formihg components of the coating compositions of the disclosure.

In a most preferred aspect of the disclosure, the ratio of isocyanate (NCO) groups of component (a3) to the sum of isocyanate-reactive functional groups in components (a1) and (a2) is less than 1.30, preferably from 0.50 to 1.25, more preferably from 0 75 to 1 10, very preferably less than 1.00, and most preferably from 0.75 to 1. 00. In particular, desirable adhesion is obtained when the ratio of NCO groups to the sum of isocyanate-reactive functional groups in components (a1) and (a2) is less than 1 30, preferably from 0.50 to 1.25, more preferably from 0.75 to 1.10, very preferably less than 1.00, and most preferably from 0.75 to 1.00 and thermally curable binder component (a2) is substantially free of functional groups having bonds activatable upon exposure to UV radiation.

The coating compositions of the disclosure further comprise additives (a4) in amounts effective for protection of the polycarbonate substrate from UV radiation. Such additives (a4) are necessary because exposure of polycarbonate to UV radiation, especially radiation in the near-violet region, can cause changes such as loss of gloss, crazing, chalking, discoloration (yellowing), embrittlement, and disintegration.

Preferred additives (a4) include ultraviolet light absorbers (UVA), light stabilizers, and blends of UVA and light stabilizers. Ultraviolet light absorbers are molecules that absorb UV light in order to reduce the degradation (photo-oxidation) caused by UV radiation. Ultraviolet light absorbers protect against UV effects by preferentially absorbing incident UV radiation and dissipating the associated energy in a harmless manner, such as transformation into longer wavelength and less energetic radiation. Generally preferred for clear coatings are ultraviolet absorbers which do not significantly affect optical clarity or transparency to visible light. Such UV absorbers are a class of stabilizers which have intense absorption up to 350 to 370 nm, but are transparent in the visible range. Ultraviolet light absorbers (UVAs) may also be known as UV screening agents and UV stabilizers.

Light stabilizers include what are known as hindered amine (or amide) light stabilizers (generally abbreviated as HALS). They are extremely efficient stabilizers against ultraviolet light-induced degradation. Unlike UV absorbers, this class of compounds reacts with peroxides and free-radical intermediates formed in the photo-oxidation process by exposure of the material to UV radiation, “scavenging” them and thereby neutralizing their harmful effects.

The UVAs included in the coating composition may be any such additives, or mixture of UVA, many of which are well known in the art. Examples of suitable UV absorbing materials are UV light absorbers such as benzophenones, benzotriazoles, triazines or benzoates, oxalanilides, and salicylates, used to absorb UV light and reduce the degradation (photo-oxidation) caused by UV radiation. Nonlimiting examples of UVAs are TINUVIN 400®, a liquid triazine; TINUVIN 1130®, a liquid benzotriazole; TINUVIN 328®; TINUVIN 234®; TINUVIN 1577®; and TINUVIN 384-2®, all produced by Ciba Specialty Chemicals.

Examples of suitable light stabilizers are HALS compounds and free-radical scavengers, generally derivatives of 2,2,6,6-tetramethyl piperidine. Non-limiting examples of HALS are TINUVIN 123®, a liquid HALS based on an aminoether functionality, TINUVIN 152®, a solid reactable HALS based on aminoether functionality, and TINUVIN 292®, a liquid HALS, all produced by Ciba Specialty Chemicals.

Because the mechanism by which HALS operates is different from UVAs, a synergistic performance enhancement is often observed when they are used together. The concurrent use or hindered amine light stabilizer with UV absorbers provides excellent stabilization in many polymer compositions as summarized by G. Berner and M. Rembold, New Light Stabilizers for High Solids Coatings, Organic Coatings and Science and Technology, Vol 6, Dekkar, New York, pp 55-85. Blends of UVAs and HALS are available commercially, for example from Ciba Specialty Chemicals.

The coating compositions of the disclosure may further optionally comprise a reactive diluent (a5) curable with actinic radiation and/or thermally. If used, reactive diluents (a5) will preferably be curable with actinic radiation and most preferably with UV radiation. Most preferably, such reactive diluents will also further comprise one or more functional groups reactive with thermally curable crosslinking component (a3). In a most preferred embodiment, a reactive diluent (a5) will be curable with actinic radiation such as UV radiation and will further comprise a plurality of functional groups reactive with isocyanate groups such as are described above with regards to functional groups of components (a1) and (a2).

Examples of suitable thermally curable reactive diluents are positionally isomeric diethyloctanediols or hydroxyl-containing hyperbranched compounds or dendrimers, as described in the patent applications DE 198 09 643 A1, DE 198 40 605 A1, and DE 198 05 421 A1.

Further examples of suitable reactive diluents are polycarbonatediols, polyesterpolyols, poly(meth)acrylatediols or hydroxyl-containing polyadducts.

Examples of suitable reactive solvents that may be used as reactive diluents include, but are not limited to, butyl glycol, 2-methoxypropanol, n-butanol, methoxybutanol, n-propanol, ethylene glycol monomethyl ether, ethylene glycol monobutyl ether, diethylene glycol monomethyl ether, diethylene glycol propanediol ether, diethylene glycol diethyl ether, diethylene glycol monobutyl ether, trimethylolpropane, ethyl 2-hydroxylpropionate or 3-methyl-3-methoxybutanol and also derivatives based on propylene glycol, e.g., ethoxyethyl propionate, isopropoxypropanol or rnethoxypropyl acetate.

Among most preferred reactive diluents (a5) that may be crosslinked with actinic radiation are for example, of (meth)acrylic acids and esters thereof, maleic acid and its esters, including monoesters, vinyl acetate, vinyl ethers, vinylureas, and the like. Examples that may be mentioned include alkylene glycol di(meth)acrylate, polyethylene glycol di(meth)acrylate, 1,3-butanediol di(meth)acrylate, vinyl (meth)acrylate, allyl (meth)acrylate, glycerol tri(meth)acrylate, trimethylolpropane tri(meth)acrylate, trimethylolpropane di(meth)acrylate, styrene, vinyl toluene, divinylbenzene, pentaerythritol, tri(meth)acrylate, pentaerythritol tetra(meth)acrylate, dipentaerythritol penta(meth)acrylate, propylene glycol di(meth)acrylate, hexanediol di(meth)acrylate, ethoxyethoxyethyl acrylate, N-vinylpyrrolidone, phenoxyethyl acrylate, dimethylaminoethyl acrylate, hydroxyethyl (meth)acrylate, butoxyethyl acrylate, isobornyl (meth)acrylate, dimethylacrylamide, dicyclopentyl acrylate, and the long-chain linear diacrylates described in EP 0 250 631 A1 with a molecular weight of from 400 to 4000, preferably from 600 to 2500. For example, the two acrylate groups may be separated by a polyoxybutylene structure. It is also possible to use 1,12-dodecylpropanediol and the reaction product of 2 moles of acrylic acid with one mole of a dimer fatty alcohol having generally 36 carbon atoms. Mixtures of the aforementioned monomers are also suitable.

Further examples of suitable reactive diluents curable with actinic radiation are those described in Rompp Lexikon Lacke und Druckfarben, Georg Thieme Verlag, Stuttgart, New York, 1998, on page 491 under the entry on “Reactive diluents”.

The coating compositions of the disclosure may further optionally comprise one or more transparent pigments and/or fillers. Examples of suitable transparent fillers are those based on silica, alumina or zirconium oxide, especially nanoparticles of these materials.

It is of particular advantage with regard to viscosity and rheology to use mixtures of transparent platelet-shaped inorganic fillers such as talc or mica and transparent, non-platelet-shaped inorganic fillers such as talc, dolomite, calcium sulfates or barium sulfate.

The amount of the above-described pigments and/or fillers in the coating compositions of the disclosure is generally from 0% to 50% by weight, based on the total nonvolatile of the coating composition, preferably from 5% to 50% by weight, more preferably from 5% to 45% by weight, with particular preference from 5% to 40% by weight, with very particular preference from 5% to 35% by weight, and most preferably from 5% to 30% by weight, all based on the total nonvolatile of the coating composition.

The dual cure coating compositions of the disclosure may further comprise one or more tackifiers. The term tackifier refers to polymeric adhesives additives that increase the tack, i.e, the inherent stickiness or self-adhesion, of the adhesives so that after a short period of gentle pressure they adhere firmly to surfaces (cf. Ullmann's Encyclopedia of Industrial Chemistry, CD-ROM, Wiley VCH, Weinheim, 1997, “Tackifiers”).

The coating compositions of the disclosure may also have one or more photoinitiators and most preferably will have at least one photoinitiator. If the coating composition is to be crosslinked with UV radiation, it is generally preferable to use a photoinitiator. When used, the photoinitiator will be present in the coating material preferably in fractions of from 0.1% to 10% by weight, more preferably from 0.2% to 8% by weight, with particular preference from 0.3% to 7% by weight, and most preferably from 0.5% to 5% by weight, based in each case on the solids of the coating composition.

Examples of suitable photoinitiators are those of the Norrish II type, whose mechanism of action is based on an intramolecular variant of the hydrogen abstraction reactions as occur diversely in the case of photochemical reactions (by way of example, reference may be made here to Rompp Chemie Lexikon, 9^{th}, expanded and revised edition, Georg Thieme Verlag, Stuttgart, Vol 4, 1991) or cationic photoinitiators (by way of example, reference may be made. here to Rompp Lexikon Lacke und Druckfarben, Georg Thieme Verlag, Stuttgart, 1998, pages 444 to 446), especially benzophenones, benzoins or benzoin ethers, or phosphine oxides It is also possible to use, for example, the products available commercially under the names IRGACURE® 184, IRGACURE® 819, IRGACURE® 1800, and IRGACURE® 500 from Ciba Geigy, GENOCURE® MBF from Rahn, and LUCIRIN® TPO and LUCIRIN® TPO-L from BASF AG. Besides the photoinitiators, customary sensitizers such as anthracene may be used in effective amounts.

The dual cure coating compositions of the disclosure may also optionally comprise at least one thermal crosslinking initiator that form radicals from 80° C. to 120° C. Examples of thermolabile free-radical initiators are organic peroxides, organic azo compounds or C—C cleaving initiators such as dialkyl peroxides, peroxocarboxylic acids, peroxodicarbonates, peroxide esters, hydroperoxides, ketone peroxides, azo dinitriles or benzpinacol silyl ethers. C—C-cleaving initiators are particularly preferred. Such thermal initiators may be present in amounts of from 0 to 10% by weight, preferably from 0.1 to 8% by weight, and in particular from 1 to 5% by weight, based in each case on the solids of the coating material.

The coating material may further comprise water and/or at least one inert organic or inorganic solvent. Examples of inorganic solvents are liquid nitrogen and supercritical carbon dioxide. Examples of suitable organic solvents are the high-boiling (“long”) solvents or low boiling solvents commonly used in coatings, for example ketones such as methyl ethyl ketone, methyl isoamyl ketone, or methyl isobutyl ketone, esters such as ethyl acetate, butyl acetate, ethyl ethoxypropionate, methoxypropyl acetate, or butyl glycol acetate, ethers such as dibutyl ether, or ethylene glycol, diethylene glycol, propylene glycol, diopropylene glycol, butylene glycol, or dibutylene glycol dimethyl, diethyl, or dibutyl ether, N-methylpyrrolidone, or xylenes or mixtures of aromatic and/or aliphatic hydrocarbons such as SOLVENTNAPHTHA®, petroleum spirit 135/180, dipentenes or SOLVESSO® (cf. also “Paints, Coatings and Solvents”, Dieter Stoye and Werner Freitag (editors), Wiley-VCH, 2^{nd} edition, 1998, pages 327 to 349).

The coating composition of the disclosure may further optionally comprise one or more coating additives in effective amounts, i.e., in amounts of up to 40% by weight, with particular preference up to 30% by weight, and in particular up to 10% by weight, based in each case on the solids of the coating composition of the disclosure. Examples of suitable coatings additives are crosslinking catalysts such as blocked sulfonic acid catalysts, dibutyltin dilaurate, or lithium decanoate; slip additives; polymerization inhibitors; defoamers; emulsifiers, especially nonionic emulsifiers such as alkoxylated alkanols and polyols, phenols, and alkylphenols, or anionic emulsifiers such as alkali metal salts or ammonium salts of alkane carboxylic acids, alkanesulfonic acids, and sulfo acids of alkoxylated alkanols and polyols, phenols, and alkylphenols; wetting agents such as siloxanes, fluorine compounds, carboxytic monoesters, phosphoric esters, polyacrylic acids, and their copolymers, polyurethanes or acrylate copolymers, which are available commercially under the tradename MODAFLOW® or DISPARLON®; adhesion promoters such as tricyclodecanedimethanol; leveling agents; film-forming auxiliaries such as cellulose derivatives; flame retardants; sag control agents such as ureas, modified ureas, and/or silicas, as described for example in the references DE 199 24 172 A1, DE 199 24 171 A1, EP 0 192 304 A1, DE 23 59 923 A1, DE 18 05 693 A1, WO 94/22968, DE 27 51 761 C1, WO 97/12945, and “Farbe+Lack”, November 1992, pages 829 ff.; rheology control additives, such as those known from the patents WO 94/22968, EP 0 276 501 A1, EP 0 249 201 A1, and WO 97/12945; crosslinked polymeric microparticles, as disclosed for example in EP 0 038 127 A1; inorganic phyllosilicates such as aluminum magnesium silicates, sodium magnesium phyllosilicates, and sodium magnesium fluorine lithium phyllosilicates of the montmorillonite type; silicas such as AEROSIL™ silicas; or synthetic polymers containing ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and their derivatives, or hydrophobically-modified₁ ethoxylated polyurethanes or polyacrylates; flatting agents such as magnesium stearate; and/or precursors of organically modified, ceramic materials such as hydrolyzable organometallic compounds, especially of silicon and aluminum. Further examples of suitable coatings additives are described in the textbook “Lackadditive” [Additives for coatings] by Johan Bieleman, Wiley-VCH, Weinheim, New York, 1998.

An important feature of the coating composition of the disclosure when applied as a coating on clear polycarbonate articles such as automotive window systems is that the coating is substantially clear and transparent. Accordingly, the aforementioned materials and additives of the coating composition should be understood to include only additives that do not significantly affect optical clarity when applied to a clear and transparent polycarbonate substrate. It should be further appreciated that the optical clarity of the coating may not change significantly over the useful lifetime of the coated article.

It will be appreciated that the coating composition of the disclosure may be used in the processes of the disclosure in different forms. For instance, given an appropriate choice of above described components (a1), (a2), and (a3), and of the further constituents that may be present, the coating composition of the disclosure may be a liquid coating composition that is substantially free from organic solvents and/or water. Alternatively, the coating composition of the disclosure may comprise a solution or dispersion of the above-described constituents in water and/or organic solvents. It is a further advantage of the coating composition of the disclosure that solids contents of up to 80% by weight, based on the coating composition of the disclosure, may be formulated. Moreover, given an appropriate choice of its constituents as described above, the coating composition of the disclosure may be a powder coating composition. Additionally, such powder coating compositions may be dispersed in water to give powder slurry coating compositions.

The coating composition of the disclosure may be a one-component or two-component system as desired. If the coating composition of the disclosure is a one-component system, the thermally curable crosslinking component (a3) may in some cases need to be blocked to prevent premature crosslinking during storage. If the coating composition of the disclosure is a two-component system, the thermally curable crosslinking component will stored separately from the other components and will not be added to them until shortly before use.

The method of preparing the coating composition of the disclosure may generally be carried out using conventional mixing of the above-described components in appropriate mixing equipment, such as stirred tanks, dissolvers, Ultraturrex, inline dissolvers, toothed-wheel dispersers, pressure release homogenizers, microfluidizers, stirred mills or extruders. It will be appreciated that appropriate measures to minimize radiation activated crosslinking should be employed, i.e., the elimination of radiation sources.

The coating composition of the disclosure may be used for the coating of a polycarbonate article.

If necessary, the polycarbonate substrate surface may be cleaned by washing with an alcohol solvent such as isopropanol, prior to application of the UV resistant coating layer. This step removes dirt, contaminants, and additives such as wetting agents from the surface.

The coating compositions of the disclosure may be applied one or more times to a polycarbonate substrate, and to more than one surface of a polycarbonate article. In such cases, the applied coatings of the disclosure may be the same or different. The coating composition may be applied directly to the polycarbonate surface, or to a primer coating already applied to the polycarbonate surface. A particularly important feature of the disclosure is that the coating composition does not require a primer coating for adhesion to the polycarbonate surface.

Illustrative application methods suitable for applying the coating compositions of the disclosure include spraying, brushing, knife coating, flow coating, dipping, rolling, and the like. Spray application methods, such as compressed air spraying, airless spraying, high-speed rotation, alone or in conjunction with hot-spray application such as hot air spraying, for example, are preferred.

The coating compositions of the disclosure will generally be applied so as to have a wet film thickness that after curing results in a dry film thickness of from 5 to 75 μm, preferably from 5 to 35 μm, more preferably from 10 to 25 μm and most preferably from 20 to 25 μm.

The coating compositions may be applied to the substrate at temperatures of no more than 93° C. (200° F.), so that appropriate application viscosities are attained without any change or damage to the coating composition of the disclosure or its overspray (which may be intended for reprocessing) during the short period of thermal stress. Hot spraying, for instance, may be configured in such a way that the coating composition of the disclosure is heated only very briefly in the spray nozzle or shortly before the spray nozzle. More preferably the coating compositions of the disclosure will be applied at a temperature of from 21° C. to 57° C. (70 to 135° F.), and most preferably at 26.7° C. to 43° C. (80 to 110° F.).

The spray booth used for application may be operated, for example, with a circulation system, which may be temperature-controllable, and which is operated with an appropriate absorption medium for the overspray, an example of such medium being the coating composition of the disclosure.

Processing and application of the coating composition of the disclosure may be done under visible light with or without wavelengths in the electromagnetic spectrum capable of activating radiation curable component (a1) or optional reactive diluent (a5). However, it will be appreciated that if application and/or processing occurs with illumination having wavelengths that could activate radiation curable component (a1) or optional reactive diluent (a5), all vessels or lines containing the coating composition of the disclosure will be covered so as to protect the coating from said illumination. In this way, pre-gelation of the coating composition of the disclosure can be avoided.

In accordance with the disclosure, polycarbonate substrates applied with the disclosed coating compositions are then exposed to actinic radiation, most preferably UV radiation, and to thermal energy to cure the coating.

Curing may take place after a certain rest period. This period may have a duration of from 0 seconds to 2 hours, preferably from 1 minute to 1 hour, and most preferably from greater than 5 minutes to less than 30 minutes. The rest period is used, for example, for leveling and devolatilization of the coat of the coating composition of the disclosure or for the evaporation of volatile constituents such as solvents, water or carbon dioxide, if the coating composition of the disclosure was applied using supercritical carbon dioxide as solvent. The drying that takes place in the rest period may be shortened and/or assisted by the application of elevated temperatures below 60° C. (140° F.), more preferably below 49° C. (120° F.), provided this does not entail any damage or alteration to the coat of the coating composition of the disclosure, such as premature thermal crosslinking, for instance.

Curing takes place preferably with actinic radiation such as UV radiation or electron beams. If desired, it may be supplemented by or conducted with actinic radiation from other radiation sources. Most preferably such first stage curing will done under an inert gas atmosphere, e.g., via the supply of carbon dioxide and/or nitrogen directly to the surface of the applied coating composition of the disclosure. In the case of UV cure, the inert gas prevents the formation of ozone.

Curing with actinic radiation may be done via customary and known radiation sources and optical auxiliary measures. Illustrative examples of suitable radiation sources are high or low pressure mercury vapor lamps, with or without lead, iron, or gallium doping in order to open up a radiation window of up to 450 nm, or electron beam sources. Metal halide emitters may also be used. Most preferred are sources of UV radiation. The arrangement of these sources is known in principle and may be adapted to the circumstances of the work piece and the process parameters. In the case of work pieces of complex shape, as are envisaged for some automobile windows, the regions not accessible to direct radiation (shadow regions) such as cavities, folds and other structure undercuts may be (partially) cured using pointwise, small-area or all-round emitters, in conjunction with an automatic movement means for the irradiation of cavities or edges. Radiation cure of the applied coating compositions of the disclosure may be effected by subjecting the applied coatings to actinic radiation in dosage amounts of from 1.5 to 15.0 J/cm², preferably from 1.0 to 10.0 J/cm², and most preferably from 2.0 to 7.0 J/cm².

The crosslink density of the coating composition, i e the degree of crosslinking, ranges from about 5% to about 100% of complete crosslinking. In particular embodiments, the density of the coatings ranges from about 35% to about 85%. In further particular embodiments, the crosslink density ranges from about 50% to about 85% of full crbsslinking. It should be understood that the presence and degree of crosslinking can be determined by a variety of methods, for example dynamic mechanical thermal analysis (DMTA). This method determines the glass transition temperature and crosslink density of free films of coatings or polymers. The measurable physical properties, e.g. tangent δ or dynamic modulus, are relatable to the structure and density of the crosslinked network.

The coating compositions of the disclosure may be said to be radiation cured when at least 75% of the radiation curable groups from component (a1) and optional component (a5) are crosslinked, preferably at least 80%, more preferably at least 90% and most preferably at least 95%, based on the total number of radiation curable groups from radiation curable component (a1) and optional reactive diluent (a5). The percentage of crosslinking of radiation curable groups may be determined by RAMAN microscope since the peak corresponding to radiation curable groups such as C═C groups decreases with increasing crosslinking. A reference peak is chosen that does not change during the curing of the coating composition. It will be appreciated that the location of the reference peak is dependent upon the chemistry of the particular coating composition and may be selected by one of skill in the art.

The equipment and conditions for these curing methods are described, for example, in R. Holmes, UV and E.B. Curing Formulations for Printing Inks, Coatings and Paints, SITA Technology, Academic Press, London, United Kingdom 1984.

Curing may take place in stages, i.e., by multiple exposure to actinic radiation. This may also be done alternately, i.e., by curing in alternation with UV radiation and with electron beams.

The thermal curing takes place in accordance with the customary and known methods such as heating in a forced air oven or exposure to IR or NIR lamps. As with the curing with actinic radiation, thermal curing may also take place in stages. Advantageously, the thermal curing takes place at temperatures of from 49° C. to 177° C. (120° F. to 350° F.), preferably between 65.5° C. to 149° C. (150° F. to 300° F.), and more preferably between 93° C. to 149° C. (200 to 300° F.), and most preferably from 107° C. to 135° C. (225° F. to 275° F.). The coatings of the disclosure may be thermally cured for a period of from 1 minute up to 2 hours, preferably 2 minutes up to 1 hour, and in particular from 5 minutes to 30 minutes.

The radiation curing and thermal curing may be employed simultaneously or alternately. Where the two curing methods are used in alternation it is possible, for example, to commence with thermal curing and to end with actinic radiation. In other cases it may prove advantageous to commence with actinic radiation curing and to end with it as well.

In another aspect of the disclosure, a process of the disclosure may comprise the application of the coating composition of the disclosure, radiation cure of the applied coating composition, application of one or more other coating compositions to the radiation cured coating composition, and subsequent joint thermal curing of both the radiation cured coating composition of the disclosure and the applied one or more other coating compositions.

It is a very particular advantage of the process of the disclosure that the polycarbonate substrate coated with the coating composition of the disclosure, following drying and exposure to actinic radiation, preferably in an incompletely cured state, may be immediately overcoated with additional coatings. The additional coatings may include another UV-blocking coating, or coatings providing additional desirable characteristics. For example, the partially cured UV-blocking coating may be further coated with scratch or abrasion resistant coatings, such as abrasion-resistant plasma coatings. Scratch or abrasion resistant coatings may comprise, but are not limited to, plasma-applied organosiloxane, wherein the film is a plasma polymerized and oxidized organosilicon coating.

Furthermore, articles coated with the coating composition of the disclosure, after drying and exposure to actinic radiation, may be subjected to thermal aftercuring, after which the coated articles of the disclosure may be stored in stacks to await further processing without risk of sticking or deformation.

The coating process of the disclosure may be performed on all sides of a polycarbonate article serving as the substrate. Coated articles, and specifically coated polycarbonate windows, according to the disclosure may have coatings on only one side, or on more than one side of the article.

The coated articles obtained by the process of the disclosure possess outstanding optical clarity. The weatherability of the coated polycarbonate articles of the disclosure is excellent. Adhesion is also substantially improved over clearcoats of the art. In particular, UV cured films of the coating composition of the disclosure have excellent adhesion to polycarbonate substrates, as well as to scratch-resistant plasma coatings, eliminating the need for an intermediate adhesion promoting coating. As a result, articles and substrates obtained by the processes of the disclosure have significantly fewer surface defects. Such defects are often referred to as porosity, microbubbles, blisters, popping, pops, or cracking.

### EXAMPLE

The disclosure is further described in the following example. The example is merely illustrative and does not in any way limit the scope of the disclosure as described and claimed. All parts are by weight unless explicitly stated to be on a different basis.

Coated polycarbonate window plaques for testing were prepared as follows: Referring to Table 1 below, urethane acrylate (a1), polyester polyol resins (a2), and surfactant were mixed in a 1-quart can for approximately 5 minutes until homogenous. A photoinitiator solution was then added. The photoinitiator solution was made from both photoinitiators and n-butyl acetate before being incorporated. A UV protection solution was then added. The UV protection solution was previously made and consisted of UV absorber (a4) and hindered amine light stabilizer (a4) in isopropanol and odorless mineral spirits (OMS) solvents. The unreduced coating composition was filtered through two mesh cones to eliminate dirt and/or other particles, and stored in a 1-quart steel can until application. A thermally curable crosslinking component (a3) was then mixed with the coating prior to application to the polycarbonate substrate/plaque for testing.

TABLE 1

| Ingredient | Example (wt %) |
|---|---|
| Polyester Polyol (a2)¹ | 28.74 |
| Urethane Acrylate (a1)² | 17.79 |
| Polyester Polyol (a2)³ | 1.43 |
| UV Absorber (a4)⁴ | 1.98 |
| HALS (a4)⁵ | 0.99 |
| Isocyanurate of HDI (a3)⁶ | 17.73 |
| Additives⁷ | 1.33 |
| Solvent⁸ | 30.02 |

¹Setal 1615-SS75 from Nuplex
²IRR 351 from UCB
³LTS adhesion resin from Creanova
⁴Tinuvin 400 from Ciba SC
⁵Tinuvin 123 from Ciba SC
⁶Desmodur N-3300 from Bayer
⁷Includes photoinitiators and leveling agents
⁸Includes n-butyl acetate (19.16), isopropanol (5.43), and odorless mineral spirits (5.43)

The coating was applied to 9″×9″ polycarbonate plaques as follows: The polycarbonate substrate was wiped with isopropanol alcohol and then dried. The coating was applied by either air atomized siphon spray directly onto the cleaned polycarbonate substrate, or by drawn down techniques Solvent was flashed off under ambient conditions for ten (10) minutes. The coated polycarbonate plaques were then cured under UVA and UVB ultraviolet radiation, at a total UV dosage of 3.0 Joules/cm². Following the UV cure, a thermal cure was conducted. The plaques were placed in a convection oven, and baked for 30 minutes at 250° F. The plaques were then coated with conventional scratch-resistant (SiO₂) plasma coating.

As can be seen in Table 2, the plaques were subjected to a 10 day humidity test to evaluate weatherability and durability in terms of adhesion and cracking. A conventional clearcoat without UVA and HALS was used as a control. After day 6, the polycarbonate plaques according to the disclosure exhibited surprisingly superior adhesion to both the polycarbonate substrate and the scratch-resistant plasma coating. Cracking was observed to be very light, with only spot delamination observed on a few of the polycarbonate plaques. When rated for cracking, the Example plaques were graded approximately 50% better than the control at an average rating of 1.6, with a rating of 1 being the best.

TABLE 2

| Descrip- | Coating | Film | Day 6% | Cracking | Inter- |
|---|---|---|---|---|---|
| tion | Application | Thickness | Adhesion | Rating | face |
| Control | Draw Down | 25 | 0 | 3 | plasma |
| Example | Draw Down | 25 | 80 | 2 | PC/ |
| | | | | | plasma |
| Example | Spray | 43 | 98 | 1 | |
| Example | Spray | 43 | 0 | 3 | plasma |
| Example | Spray | 33 | 60 | 0 | PC |
| Example | Draw Down | 25 | 0 | 2 | PC |
| | | AVERAGE | 47.6 | 1.6 | |

The optical clarity of the polycarbonate plaques coated with the coating of the disclosure was also subjectively evaluated. Excellent optical clarity of the plaques coated with the composition of the disclosure was noted.

The disclosure has been described herein with reference to preferred embodiments. It should be understood, however, that variations and modifications can be made within the spirit and scope of the disclosure.

What is claimed is:

1. A polycarbonate article comprising a polycarbonate substrate having optical transparency, said polycarbonate substrate coated with at least one coating prepared by curing a composition comprising
(a1) a radiation curable component that polymerizes upon exposure to actinic radiation comprising
at least two functional groups comprising at least one bond that is activatable upon exposure to actinic radiation,
(a2) a thermally curable binder component that polymerizes upon exposure to heat comprising
at least two functional groups that are reactive with functional groups of component (a3);
(a3) a thermally curable crosslinking component comprising at least two functional groups that are reactive with the functional groups of component (a2); and
(a4) at least one additive for protection of the polycarbonate substrate from UV radiation;
wherein the coating composition is curable upon exposure to both actinic radiation and thermal energy, and the coating composition reduces the exposure of the polycarbonate substrate to ultraviolet radiation.

2. The polycarbonate article according to claim 1, wherein radiation curable component further comprises at least one isocyanate-reactive functional group.

3. The polycarbonate article according to claim 1, wherein radiation curable component further comprises at least one hydroxyl-reactive functional group.

4. The polycarbonate article according to claim 1, wherein the composition further comprises at least one reactive diluent (a5).

5. The polycarbonate article according to claim 1, wherein the coating is substantially clear and transparent.

6. The polycarbonate article according claim 1, wherein at least 5% up to 100% by weight based on a nonvolatile weight of component (a2) is a component (X) that is a polymer with at least two functional groups, a glass transition temperature of less than 0° C., and an equivalent weight of greater than 225 grams per equivalent.

7. The polycarbonate article according to claim 6, wherein component (X) comprises at least one of a polyether diol, polyether polyol, a polyester diol, and a polyester polyol.

8. The polycarbonate article according to claim 7, wherein the polyether diol comprises at least one of polyethylene oxide, polypropylene oxide, and polytetrahydrofuran.

9. The coating composition of claim 7, wherein the polyester diol is a polylactone.

10. The polycarbonate article of claim 7, wherein the polyester polyol is a ε-caprolactone extension of pentaerythritol.

11. The polycarbonate article of claim 6, wherein component (X) has a glass transition temperature of less than −20° C.

12. The polycarbonate article of claim 6, wherein component (X) has a glass transition temperature of less than −50° C.

13. The polycarbonate article of claim 6, wherein component (X) has an equivalent weight of greater than 265 grams per equivalent.

14. The polycarbonate article of claim 8, wherein component (X) is a polytetrahydrofuran.

15. The polycarbonate article of claim 1, wherein the radiation curable component (a1) polymerizes upon exposure to ultraviolet radiation.

16. The polycarbonate article of claim 1, wherein the thermally curable binder component (a2) comprises at least two isocyanate reactive functional groups.

17. The polycarbonate article of claim 16, wherein the at least two isocyanate reactive functional groups are hydroxyl groups.

18. The polycarbonate article of claim 1, wherein the thermally curable crosslinking component (a3) comprises at least two isocyanate groups

19. The polycarbonate article of claim 1, wherein the at least two functional groups of component (a3) are isocyanate groups, and a ratio of isocyanate groups to a sum of functional groups of components (a1) and (a2) is less than 1.3.

20. The polycarbonate article of claim 19, wherein the ratio is less than 1.0.

21. The polycarbonate article of claim 19, wherein the ratio is from 0.5 to 1.25.

22. The polycarbonate article of claim 19, wherein the ratio is from 0.75 to 1.0.

23. The polycarbonate article of claim 1, wherein the thermally curable binder component (a2) comprises less than 5% by weight of aromatic ring moieties based on the nonvolatile weight of the thermally curable binder component (a2).

24. The polycarbonate article of claim 2, wherein the isocyanate-reactive functional group of component (a1) is at least one of a thiol group, a primary amino group, a secondary amino group, and imino group, and a hydroxyl group.

25. The polycarbonate article of claim 3, wherein the hydroxyl-reactive functional group of component (a1) is at least one of an isocyanate, an aminoplast, an epoxide, a silane, a cyclic anhydride, and a cyclic lactone.

26. The polycarbonate article of claim 25, wherein the hydroxyl-reactive functional group is an isocyanate.

27. The polycarbonate article according to claim 1, further comprising a scratch-resistant coating.

28. The polycarbonate article according to claim 27, wherein the scratch-resistant coating is a plasma polymerized and oxidized organosilicon coating.

29. The polycarbonate article according to claim 1, wherein the polycarbonate substrate is a window.

30. The polycarbonate article according to claim 30, wherein the polycarbonate substrate is an automotive window.

31. A method of producing a polycarbonate article, comprising:
applying a coating composition to an optically transparent polycarbonate article, said coating composition comprising
(a1) a radiation curable component that polymerizes upon exposure to actinic radiation comprising
at least two functional groups comprising at least one bond that is activatable upon exposure to actinic radiation,
(a2) a thermally curable binder component that polymerizes upon exposure to heat comprising
at least two functional groups that are reactive with functional groups of component (a3);
(a3) a thermally curable crosslinking component comprising at least two functional groups that are reactive with the functional groups of component (a2);
(a4) at least one additive for protection of the polycarbonate substrate from UV radiation; and
subjecting the coated article to actinic radiation and thermal energy sufficient to cure the coating composition.

32. The method of claim 31, wherein the actinic radiation is UV radiation.

33. The method of claim 31, wherein the coating is applied by means chosen from the group consisting of spraying, brushing, knife coating, flow coating, dipping, and rolling.

34. The method of claim 33, wherein the coating is applied by at least one spraying application method comprising compressed air spraying, airless spraying, high-speed rotation, or hot air spraying.

35. The method of claim 31, further comprising applying at least one additional coating.

36. The method of claim 35, wherein the at least one additional coating is a scratch-resistant coating.

37. The method of claim 31, further comprising cleaning prior to applying the coating composition, wherein dirt, contaminants, and additives are removed from the surface.
